(19) United States
(12) Patent Application Publication
(10) Pub. No.: US 2006/0294571 A1
(43) Pub. Date: Dec. 28, 2006

(54) Collaborative video via distributed storage and blogging

(75) Inventors: George M. Moore, Issaquah, WA (US); Steven J. Ball, Seattle, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/167,749

(22) Filed: Jun. 27, 2005

(51) Int. Cl. H04N 7/16; H04N 7/173; G06F 13/00; H04N 5/445; G06F 3/00

(52) U.S. Cl. 725/135; 725/136; 725/41; 725/112; 725/113

(57) ABSTRACT

Systems and methods for sharing video or media content on a distributed network are disclosed. End users may be induced through a variety of ways to allocate some amount of unused disk space and otherwise idle bandwidth for storing media produced in a blogging or web-publishing context. For example, when a user creates a blog, the user may link certain video or media files to it. Such video may be kept in a distributed store across a variety of peer machines. If a visitor visits the blog, the visitor may see contextual ads based upon the subject matter associated with the blog, and the blog owner may receive a share of the advertising revenue generated. A visitor may download the video and combine it with new content. Thus, composite media files may be created from sections taken from any number of previously created video clips, each of which may be associated with a different owner. The composite media files may include pointers to any or all of the original owners, as well as the respective length of each included section. The composite video may then be added to a different blog. Anyone visiting the new blog may also see contextual ads, with pro-rated portions of the generated ad revenue flowing proportionally to each of the original media owners.

### CROSS-REFERENCE TO RELATED APPLICATIONS

The subject matter disclosed and claimed herein is related to the subject matter disclosed and claimed in U.S. patent application Ser. No. 11/110,128, filed on Apr. 20, 2005, entitled “Systems And Methods For Providing Distributed, Decentralized Data Storage And Retrieval,” the disclosure of which is hereby incorporated herein by reference.

### FIELD OF THE INVENTION

Generally, the invention relates to methods for sharing video content on a distributed network. More particularly, the invention relates to a cost-effective method for collaborative video via distributed storage.

### BACKGROUND OF THE INVENTION

Two of the hottest trends in ad-hoc collaboration on the Internet—blogging and podcasting—tend to be limited to the textual and auditory world. A “blog,” (short for “weblog”) as that term is used herein, refers to a website that is set up for visitors to read, view, retrieve, and/or post information. “Podcasting,” as that term is used herein, refers to a peer-to-peer system whereby people can create their own audio files and share sound files (e.g., MP3, WMA, WAV), and other people can easily download and listen to audio on their PCs and other mobile listening devices. Thus, podcasting is a mechanism that may be used for delivering audio in a personalized fashion—that is, the content is posted and shared by individuals, and discovered and pulled across the internet by other individuals requesting the content via direct links or syndication and/or subscription services.

Though video is also a useful exchange medium, it suffers from the fact that video files are many times larger than audio (and orders of magnitudes larger than simple text), which means the storage of the video and the bandwidth to stream the video is and will continue to be prohibitively expensive for the foreseeable future. As a result, an advertiser-supported business around collaborative or non-Hollywood, internet-distributed video tends to be unprofitable because the capital expenditure costs for disks in a data center and the operational costs for bandwidth from a data center are far more expensive than revenue one could potentially generate via advertising revenue.

Typically, a blog host has to spend money for server space to keep their blog running. In an effort to capitalize on the blog host's desire to recoup money spent to provide the blog, ad providers began to exchange permission to put ads onto the blogs for a share of the ad revenue. Google, for example, has recently begun using its ad provision service, AdSense, in the blog context. In such an environment, the blog host can put up HTML text next to the blog so that when someone visits the site, the visitor gets context-specific advertising in the frame of the blog. Typically, the ad provider gets paid by the advertiser for providing this service. If a visitor clicks on a link provided in the advertising, then the ad provider “monetizes” the link (i.e., deposits a certain amount of money (or other currency, such as miles, etc.) into an account associated with the blog host). Thus, the blog host receives a share of the advertising revenue generated by the ad.

To build a business around collaborative video, however, one must either charge a lot of money to store and stream the video from a centralized data center, or find a different way to store and distribute video content to end users. Unfortunately, charging for video tends to severely impact grassroots growth because people are unlikely to pay a lot of money to see amateur or semi-professional video content, no matter how narrowly defined the subject matter may be. For such a model to succeed, it is desirable to provide free viewing of video content while providing a scalable, non-obtrusive ad model that is not perceived by users as so annoying or disruptive that they would seek other content via other means.

It would be desirable, therefore, if systems and methods were available that changed the economics around storage and distribution of video content in order to make such storage and distribution cost-effective and profitable for collaborative video.

### SUMMARY OF THE INVENTION

The invention provides a cost-effective mechanism for sharing video content on the Internet that establishes a peer-to-peer edge-based storage and routing service for such video. End users may be induced through a variety of ways to allocate some amount of unused disk space or idle bandwidth for this service. Thus, the video may be stored over a distributed network of nodes, and the capital and operating expenditures for such a service may be borne entirely by a loose federation of client machines rather than by a centralized data center. Systems and methods for providing distributed, decentralized data storage and retrieval are disclosed and claimed in U.S. patent application Ser. No. 11/110,128.

An aspect of the invention may include blending or mixing and combining user-authored video content with blogs or other web-based publishing mechanisms. For example, a user can create, edit or host a piece of video content, create a blog, and link that video to the blog (in multiple formats). The video may be kept in a distributed store across a number of deputized peer machines. If someone visits the blog, the visitor may see contextual ads based upon the subject matter of the video itself, it's author, or the blog or site that hosts the content, and the blog owner, acting as a middleman in the distribution process, may therefore receive a share of that advertising revenue associated with the ads or associated with the actions taken based upon viewing those ads. The video may also include metadata that points back to the user as the owner, and to the user's blog.

Anyone can then freely download the video and edit or combine it with new content (e.g., “mash-ups,” collage-style videos made from an assortment of moving and still images that are combined to form a derivative work from a number of dis-separate elements). The newly created video may include one or more pointers to downstream owners, as well as useful metadata such as the relative length of the included sections, original author information, details about the images/content used, etc. The new video may then be added to a different blog. Anyone visiting the new blog may also see contextual ads, and a pro-rated portion of the ad money may flow to each owner in the stream. Thus, the invention builds on and extends the ideas within a classical multi-tiered marketing system where creators of works that are used widely in many downstream derivative works could see a healthy revenue stream based upon the percentage of content they provide and in proportion to the number of additional distributions they have enabled by hosting and distributing the new content. This same model could just as equally be applied to an “audio-only” content system, and in no way assumes that video content is the only kind of media to which this invention could be applied.

### BRIEF DESCRIPTION OF THE DRAWINGS

FIG. 1 is a block diagram showing an example computing environment in which aspects of the invention may be implemented.

FIG. 2 depicts an example of a distributed network.

FIG. 3 is a flowchart of an example embodiment of a method according to the invention for collaborative video via distributed storage and blogging.

FIGS. 4A and 4B depict an example distributed storage system.

### DETAILED DESCRIPTION OF ILLUSTRATIVE EMBODIMENTS

Example Computing Environment

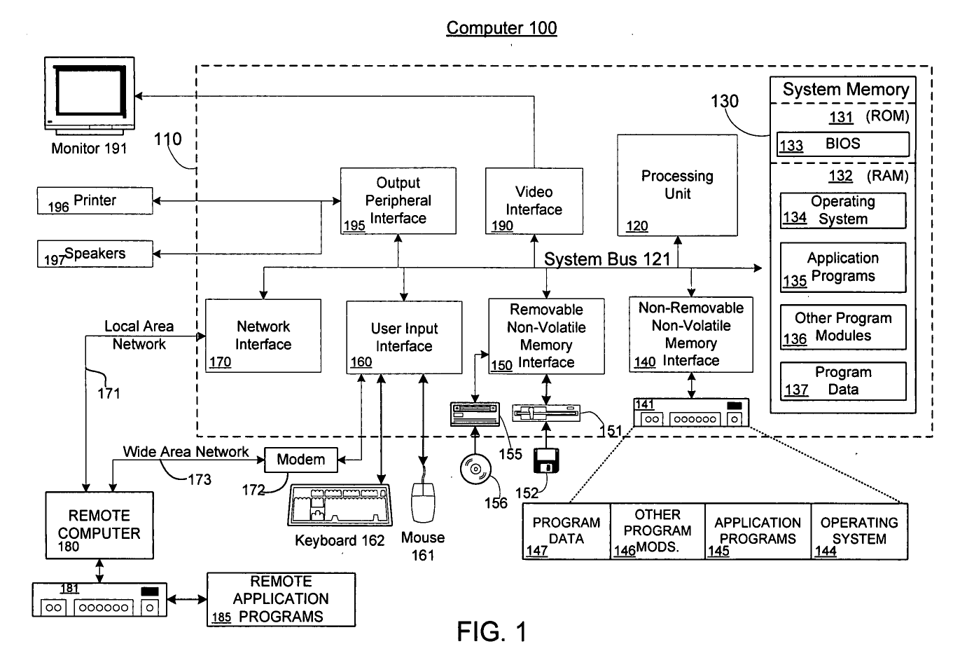

FIG. 1 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

Example Distributed Network

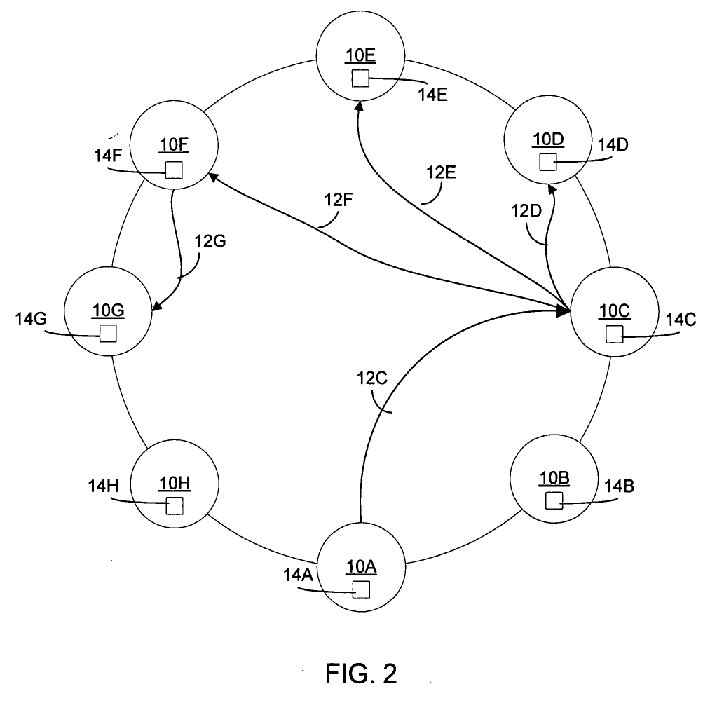

FIG. 2 depicts an example of a distributed network comprising a plurality of network nodes 10A-H. Such a node may be a personal computer, for example, or any other network device that includes processing and data storage capabilities, such as, for example, a server, a router, a network PC, a peer device, etc. The nodes 10A-H may be peers that are interconnected to one another over a local- or wide-area-network such as an intranet or the Internet, for example.

Each node 10A-H may be assigned a unique address. The length of the address may be chosen in order to ensure that each node has a unique address. In an example, Internet-based system, where the network is expected to include tens of millions of nodes, 160-bit addresses may be used. Such an addressing scheme may form a routing overlay on top of the transmission control protocol (“TCP”).

Processes distributed among the several nodes 10A-H may communicate with each other over the network via simple object access protocol (“SOAP”) messages. SOAP is a well-known, lightweight, XML-based distributed computing protocol. A SOAP message is an XML document that includes a SOAP envelope. The envelope includes an optional SOAP header and a mandatory SOAP body. The SOAP message header represents the metadata of the message and provides a way to extend SOAP. The SOAP message body is the actual message payload. The distributed processes may communicate with one another by putting SOAP packets onto the network.

A process may be a message originator (e.g., on node 10A as shown), an intended message receiver (e.g., on node 10G as shown), or an intermediary (e.g., on node 10C as shown). The message originator is the process that originally puts the SOAP message onto the network. The intended message receiver is the process to which the message is ultimately destined. Accordingly, a SOAP message originating from the message originator may include an address associated with the intended message receiver.

Collaborative Video Via Distributed Storage And Blogging

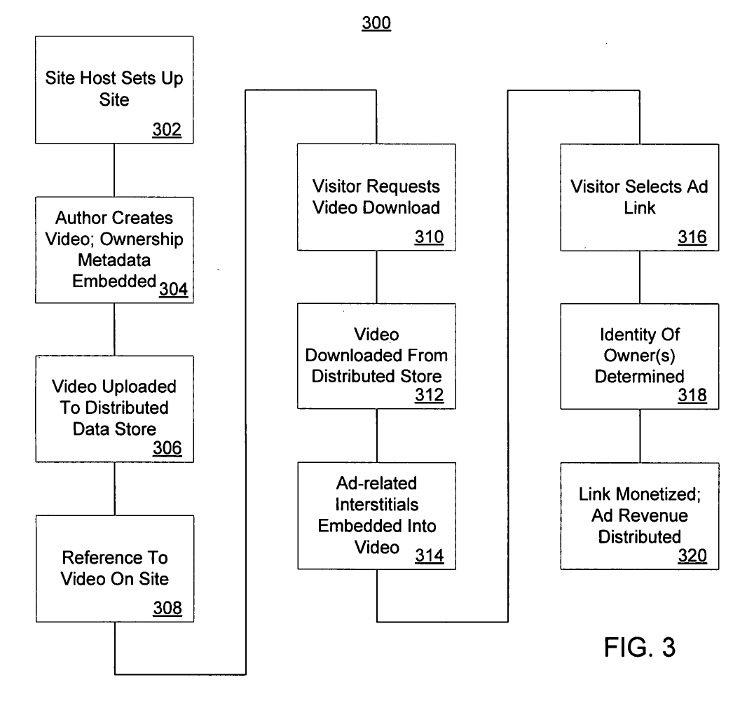

FIG. 3 is a flowchart of an example embodiment of a method 300 according to the invention for collaborative video via distributed storage and blogging. It should be understood that, though the example embodiments described herein are described in connection with blogging, the principles of the invention may be applied to other services, such as podcasting, for example, and to other web sites or content publishing or collaboration mechanisms, such as wikis, for example. A “wiki,” as that term is used herein, refers to a community-based database, like an encyclopedia, for example, where people can contribute to or edit information based, presumably, on personal knowledge. A similar system could be also be easily applied to an intranet-based distance-learning or educational application, for example.

At step 302, a site host sets up a blog, wiki, or other web site (generically referred to herein as a “site”). At step 304, a first author who may or may not be the site host, creates and edits a video using a video editor—the video created may be comprised of pre-existing pieces or totally original ‘clips’ that the user has compiled, created, or acquired my any known means. A video editor is used to sequence the individual elements into a new derivative work based upon the pre-existing or captured ‘clips’ and the editor is to be designed in way that it embeds into the video file specific metadata tags that establish a hierarchy of authorship that defines the relative ‘ownership’ of each of the clips used in the final ‘bounced’ compilation. (Bouncing is defined as the ‘rendering’ step where the edits, cross-fades, and authors decisions are committed to one final hard-wired sequence and stored in an external file on some physical medium, ready for distribution. The author/editor of the final ‘bounced’ video content is also validated owner of the new ‘compilation’ video.

It should be understood that, although the author of the video is often, but not always, the owner the rights in the video—in many cases, the author is not actually the owner of all of the source content that is included in the video. Accordingly, the metadata could refer to either the author, the sub-clip owners, or both. The terms “author” and “owner” may be used interchangeably herein to signify the owner of the rights in the video authored by the author.

At step 306, the first author uploads their ‘bounced’ video to a distributed data store, with the embedded ‘ownership’ tree baked into the final video file itself. An example of such a distributed, decentralized data store is disclosed and claimed in U.S. patent application Ser. No. 11/110,128. Such a system may include an interconnected network of nodes. Each node may be a PC, for example, or other network-connected device that includes a memory for storing electronic data, such as a portion of the video file.

Incentives may be provided to encourage node owners to make such storage space available to the community. For example, owners who consent to provide such storage space may also receive a portion of any ad-generated revenue stream. Alternatively, the owner may merely receive a quid pro quo. For example, in exchange for permitting other people's family photos to be backed up onto his machine, the owner may be entitled to have his family photos backed up onto someone else's machine.

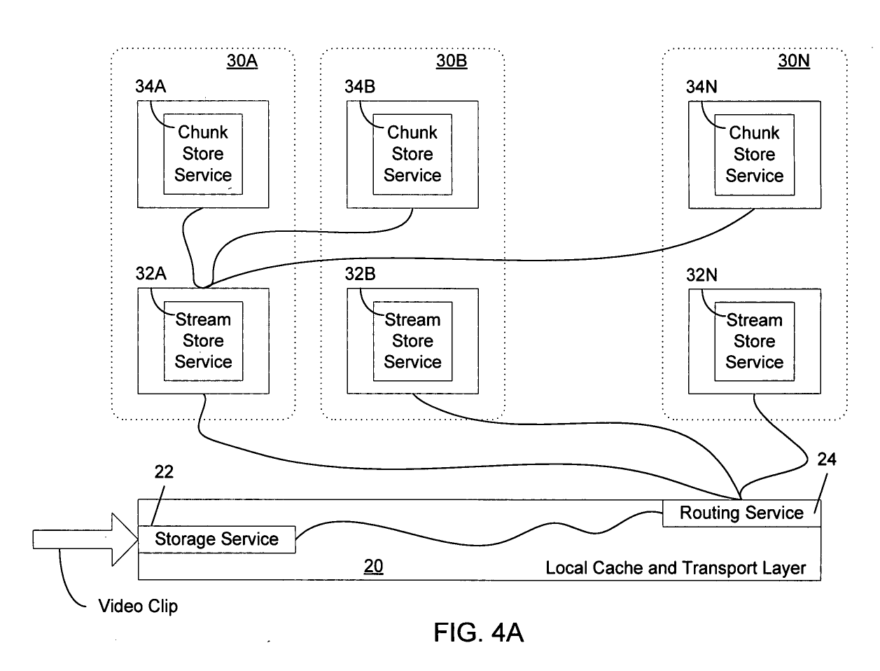

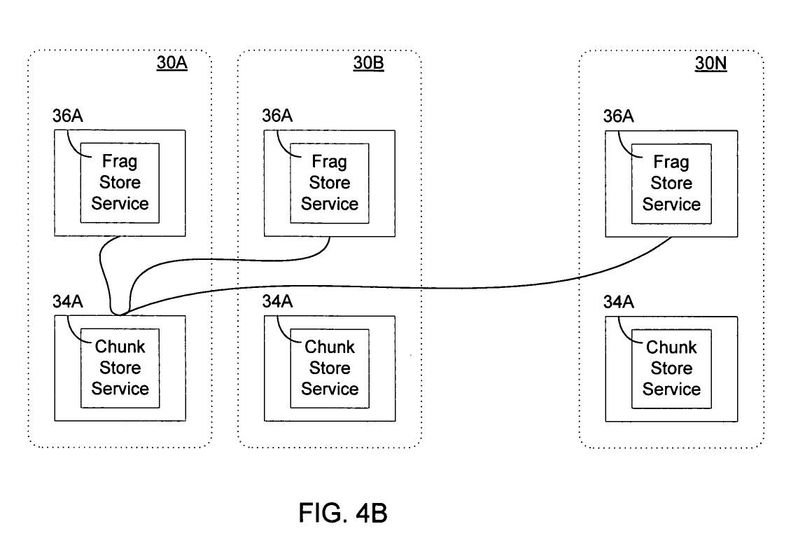

As shown in FIGS. 4A-B, and described in detail in U.S. patent application Ser. No. 11/110,128, each node may have running thereon a collection of one or more processes that form a “local cache and transport layer,” a “stream store layer,” a “chunk store layer,” and a “fragment store layer.” A collection of processes may also be provided for “block” storage.

The local cache and transport layer 20 may include a storage service 22 and a routing service 24. The storage service 22 may receive a storage request to store the video clip, which may be a bit stream of arbitrary length. The routing service 24 may communicate the video clip to any of the stream store services 32A-N. The stream store service may store a video clip in local persistent storage for later retrieval, and also divide the clip into one or more “chunks.” The stream store service (e.g., 32A) may then communicate the chunks to respective chunk store services 34A-N. The chunk store service may store the chunk in local persistent storage for later retrieval, and also divide the chunk into one or more “fragments.” The chunk store service (e.g., 34A) may then encode the fragments into check blocks and communicate them to respective fragment store services 35A-N. The fragment store service may store the fragment in local persistent storage for later retrieval. Thus, a video clip may be divided into a plurality of check blocks, and each check block stored, in general, on a different node distributed over a vast network of such nodes.

It should be understood that, to authenticate ownership of a specific video clip, a certificate that includes detailed hierarchy of ownership information could be placed alongside or within the clip itself. Accordingly, the system could prevent new video from being stored on the distributed network unless the video includes a proper certificate. The system could require a would-be author to provide a proper key in order to store/access/delete material on the distributed store. Thus, only authorized persons could tamper with material stored on the distributed store.

At step 308, the first author may make a reference to a video on a site. At step 310, a visitor visits the site where the first author's video is available, and selects to download the video. At step 312, the video is retrieved from the distributed data store and, preferably, streamed to the requesting node.

As described in detail in U.S. patent application Ser. No. 11/110,128, in order to retrieve the video, the routing service 24 in the local cache and transport layer 20 may put a message onto the network requesting that the video be retrieved from the node(s) on which it is stored. If the video is still stored in local cache associated with a stream store service, then the stream store service returns the video in one or more packets to the node that requested it. If the video is not still stored in the local cache associated with that stream store service, then the stream store service requests the associated chunks from the chunk store services to which those chunks were sent during the storage process. If a chunk remains in local cache associated with that chunk store service, then that chunk is returned to the node that requested it. If not, then the chunk store service requests the associated fragments from the nodes on which those fragments were stored. This process continues—retrieving check blocks to reconstitute fragments, retrieving fragments to reconstitute chunks, retrieving chunks to reconstitute the video clip, until the full video clip is reconstituted and returned to the node that requested it.

When the visitor selects to download or access the video, relevant ad-related interstitials may be embedded dynamically into the video stream in appropriate locations within the video content itself at step 314. Interstitials may be deemed “relevant” based on intelligent demographic information, personal information, associated metadata, for example, associated with the visitor, the hosting site, or other mechanisms that would potentially make the ad content more valuable and relevant to the viewer. One or more text, close-captioned, audio or visual interstitials could be interspersed throughout a video clip to provide an advertisement based value-add to the original content itself. The interstitials may also be advertisements that appear while the video is downloading. The advertisements may also include links to other web pages, for example, associated with the advertised good or service so the viewer could immediately gain access to mechanisms for follow-up, additional data, or additional online sales opportunities for those items that attract their attention in the content or in the ads themselves.

At step 316, a visitor may click on a link provided in the advertising or in the video content itself. According to an aspect of the invention, a percentage of ad revenue may go to one or more authors associated with the video stream according to the percentage of content by each author has been actually viewed by the user. For example, if the user only views ½ of a given video program, the authorship share could be calculated only based upon those clips and associated authors that exist in the first half of the video clip. If, at step 316, the visitor clicks on a link provided in advertising embedded in a video stream authored by a certain author, then, at step 318, the identities of the authors may be determined from the metadata tags embedded in the video stream.

At step 322, the link is “monetized.” That is, the ad provider may deposit a certain amount of currency into an account associated with the site owner or on behalf of any third party collection/distribution agency who may distribute ad royalties to content owners. The currency could be money, for example, or it may also be any other form of payment, such as frequent flyer miles, ad-free viewing time, or other value-based barter mechanisms, etc. Thus, the site owner may receive a share of the advertising revenue generated by the ad. In accordance with an aspect of the invention, a predefined amount of currency may also be deposited into an account associated with the owner of the video. The amount of currency to be deposited into the owner's account may be a percentage of the currency the site owner receives from the ad service provider and may be based on a pre-existing business arrangement between the video author/owner and the site owner.

According to an aspect of the invention, a ‘hierarchy’ of authors may receive a portion of the advertising revenue associated with a video clip. For example, a second author may download a first author's video, and use all or a portion of the first author's video to make a second video. Thus, the second video may be a composite video that includes a union of the second author's new material with some or all of the first author's material. In this case, the author of the ‘composite’ video is creating a derivative work and is the primary owner of that derivative work, however the collective ‘ownership’ of the final content is shared based upon an equitable pre-established equation between all owners of the pieces that were used to create the new composite. According to an aspect of the invention, such a hierarchy equation may be to establish ownership percentages for iteratively composited materials.

As described above in connection with the first video, the second video may be embedded with metadata containing an embodiment of the hierarchy of ownership and lineage of the second video. In this case, the video may be owned by the second author. The metadata may indicate that the video is composed of material from both the first author and the second author, and perhaps a long string of previous authors. If partial clip gets moved to another clip, owner's name, metadata, tracking information, and stable URI that points to location it came from gets moved into new clip. The metadata may also indicate how much of the video is material from the first author and how much is material from the second author. For example, the metadata may indicate that a first percentage of the video is material from the first author and a second percentage of the video is material from the second author. The second video may be uploaded to the distributed store, and referenced in a site that may be the same as or different from the first site.

The video editing software used by the second author may embed and pass on the combined video metadata associated with each of the first author and the second author in a manner that is transparent to the second author. Typically, a video editing software application may include a button or function that the author may select to “publish’ or ‘bounce’ or ‘render’ a final new piece of content, and indicate that the editing process is complete. The current version of Microsoft's MOVIE MAKER, for example, includes a “Make Final Video” button. In accordance with an aspect of the invention, such video editing software may be modified such that, when the final video button is selected, metadata associated with each author is embedded into the video.

The video editor may embed into the video clip metadata including one or more pointers to a site at which the video clip (created by the second author) was originally made available. Similarly, the video editor may embed into the video clip metadata including one or more pointers to sites at which the content created by the first author was originally made available.

For security purposes, the video editor may embed into the video clip a respective certificate associated with each of the first and second authors, thereby preserving the identity and security of ownership and metadata such that a hacker could not arbitrarily influence the content ownership ecosystem enabled by this embedded metadata. Embedding a certificate may include watermarking the video clip with respective technology-based, but user invisible, watermarks associated with each of the first and second or subsequent authors.

A visitor to the second site may be presented with contextual ads generated from the ad provider based on the content or themed interests associated with the second site. A share of the ad revenue may go to the second author, a share to the website service provider, and a share to the ad provider who manages and maintains the ad streams. Additionally, a pro-rated share of the ad revenue (which may be referred to as a “micropayment”) may also be sent to the first author. In an example embodiment, the more video or audio that the second author used from the first author's video, the greater the pro-rated share the first author may receive.

The process may similarly repeat for any number of authors. A third author may use a respective portion of each of the first and second author's videos, in addition to entirely new video. For each clip used to make the combined video, the video editor may embed respective metadata associated with the respective author of the clip. Thus, in a manner that is transparent to the author, the video editor may embed into the video metadata associated with each clip from which the combined video was made. In this case, the third author may give a respective portion of his share of the advertising revenue to each of the first and second authors.

Thus, there have been described systems and methods for sharing collaboratively-created video content on a distributed network. Though the invention has been described in connection with certain preferred embodiments depicted in the various figures, it should be understood that other similar embodiments may be used, and that modifications or additions may be made to the described embodiments for practicing the invention without deviating therefrom. The invention, therefore, should not be limited to any single embodiment, but rather should be construed in breadth and scope in accordance with the following claims.

What is claimed:

1. A decentralized, peer-to-peer, distributed storage system comprising:
a first collection of one or more services operative to receive a request for storage of a digital video or media clip, said digital video clip including a hierarchy of ownership metadata identifying a primary owner, said first owner associated with at least a first portion of the digital video clip; and
a second collection of one or more services operative to cause the digital video clip to be stored in a distributed manner over a plurality of network nodes that are communicatively coupled to the network.

2. The system of claim 1, wherein the second collection of services is operative to divide a video or media clip into a plurality of check blocks, and to distribute the check blocks for storage on respective ones of the plurality of network nodes.

3. The system of claim 1, further comprising a third collection of services operative to retrieve and recombine a video or media clip from the plurality of network nodes.

4. The system of claim 3, wherein the third collection of services is operative to reconstitute a video or media clip and to stream the video clip to a requesting network node from which the video was requested.

5. The system of claim 4, wherein the third collection of services is operative to dynamically embed ad-related interstitials ads or other useful content into the video clip before or during delivery of the video clip to the requesting network node.

6. The system of claim 1, wherein a digital video or media clip includes metadata identifying an ownership hierarchy including a second, third, or subsequent owners associated with a sub-portions of the digital video or media clip.

7. The system of claim 1, wherein a digital video or media clip includes metadata including one or more pointers to a network-based site or location or mechanism for identifying a source at which the video clip was previously made available.

8. The system of claim 1, wherein the digital video or media clip includes metadata including one or more pointers to a network-based site at which the first portion of the video clip was previously made available.

9. A method for distributing ad-generated revenue, the method comprising:
storing a video or media clip in a distributed manner over a plurality of network nodes that are communicatively coupled to a network, said digital video clip including metadata identifying a first owner, said first owner associated with at least a first portion of the digital video clip;
dynamically embedding an ad-related interstitial into the video clip before or during delivery of the video clip to a requesting network node from which the video was requested; and
allocating a first amount of revenue to the first owner if an ad link generated by the ad-related interstitial is selected at the requesting node.

10. The method of claim 9, wherein the digital video or media clip includes metadata identifying a second and/or subsequent owners, said second owners associated with a sub-portion of the digital video or media clip, the method further comprising:
allocating a second proportional amount of revenue to the second owner if the ad link is selected at the requesting node.

11. The method of claim 10, wherein the metadata identifies a first percentage of the video or media associated with the first owner and a second percentage of the video associated with the second owner, the method further comprising:
allocating an “ownership hierarchy” whereby the first and second amounts to the first and second owners, respectively, on a pro rata basis based on the respective percentages associated with each.

12. The method of claim 9, wherein the revenue includes a cash or equivalent payment.

13. The method of claim 9, wherein the revenue includes a non-cash payment.

14. The method of claim 9, wherein respective owners of each of the plurality of network nodes is compensated in exchange for providing storage space for data associated with at least a portion of the video clip.

15. A method for generating a video or media clip to ascribe ownership of at least a portion of the video clip, the method comprising:
receiving a video or media clip created by a first author, said video clip including first content created by the first author and second content created by a second author; and
embedding into the video clip metadata identifying each of the first and second authors.

16. The method of claim 15, further comprising:
embedding into the video clip metadata including one or more pointers to a first network-based site at which the video clip was originally made available.

17. The method of claim 16, further comprising:
embedding into the video clip metadata including one or more pointers to a second network-based site at which the content created by the second author was originally made available.

18. The method of claim 15, further comprising:
embedding into the video clip a respective certificate associated with each of the first and second authors.

19. The method of claim 18, wherein embedding the certificate into the video clip includes watermarking or tagging the video or media clip with respective watermarks associated with each of the first and second authors.
